(19) United States
(12) Patent Application Publication
(10) Pub. No.: US 2009/0119313 A1
(43) Pub. Date: May 7, 2009

(54) Determining structure of binary data using alignment algorithms

(75) Inventor: Walter H. Pearce, (US)

Correspondence Address: K&L GATES LLP, 535 SMITHFIELD STREET, PITTSBURGH, PA, 15222, US

(73) Assignee: IOActive Inc.

(21) Appl. No.: 11/982,659

(22) Filed: Nov. 2, 2007

(51) Int. Cl. G06F 17/30

(52) U.S. Cl. 707/100; 707/E17.044

(57) ABSTRACT

Systems and methods for determining structure of two or more binary data strings. The method may comprise the steps of: (1) sorting the data strings by similarity; (2) recursively aligning the data strings; and (3) creating a length-based schema map of similar segments in the data strings. Global and/or local recursive alignment algorithms may be used to align the data strings. The Needleman-Wunsch algorithm could be used for the global alignment and the Smith-Waterman algorithm could be used for the local alignment. A Bayesian classifier could be used to sort the data strings by similarity. Also, the sorted data strings could be scored for similarity prior to the recursive alignment. The length-based schema map of similar segments may be created following the recursive alignment based on: (1) a gap fielding analysis that determines the size of gaps in the data strings detected in the recursive alignment; (2) a gap variance analysis that determines the variance in the size of the gaps; and (3) a data type detection analysis that detects the type of data represented by the segments.

### BACKGROUND

One of the tasks commonly involved in computer security assessments is the analysis of binary data to determine the structure (if any) to the data. Currently, such analysis is usually performed manually or using heuristic algorithms. These techniques are time consuming and error prone.

### SUMMARY

In one general aspect, the present invention is directed to systems and methods for determining structure of two or more binary data strings. According to various embodiments, the method may comprise the steps of: (1) sorting the data strings by similarity; (2) recursively aligning the data strings; and (3) creating a length-based schema map of similar segments in the data strings.

According to various implementations, global and/or local recursive alignment algorithms may be used to align the data strings. For example, the Needleman-Wunsch algorithm could be used for the global alignment and the Smith-Waterman algorithm could be used for the local alignment. A Bayesian classifier could be used to sort the data strings by similarity. Also, the sorted data strings could be scored for similarity prior to the recursive alignment. The length-based schema map of similar segments may be created following the recursive alignment based on: (1) a gap fielding analysis that determines the size of gaps in the data strings detected in the recursive alignment; (2) a gap variance analysis that determines the variance in the size of the gaps; and (3) a data type detection analysis that detects the type of data represented by the segments. According to various embodiments, the length-based schema map may be an XML-length-based schema map.

The schema may be used to test software or computer-based applications. For example, the schema could be used to generate a number of arbitrary files based on the schema. Those files could then be run through the application to see how the application performs, e.g., to see if the application crashes. Another use of the schema is reverse engineering an application. Using the above-described process, a schema based on output binary data files from the application to be reverse-engineered may be generated. The structure of these files may then be ascertained, which may be beneficial to creating applications that interface with the application

### FIGURES

Various embodiments of the present invention are described herein by way of example in conjunction with the following figures, wherein:

FIG. 1 is a diagram of a system for analyzing binary data according to various embodiments of the present invention; and

FIG. 2 is a flowchart of a process to be performed by the system of FIG. 1 according to various embodiments of the present invention.

### DETAILED DESCRIPTION

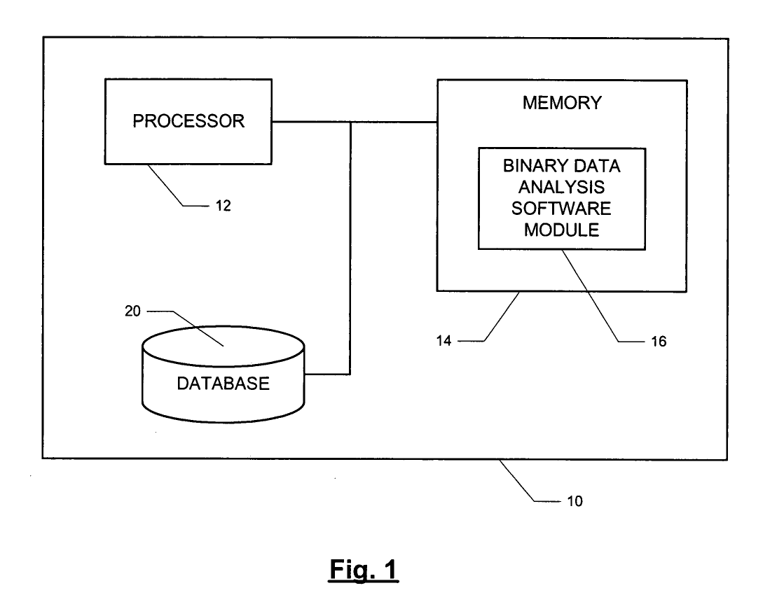

FIG. 1 is a diagram of a system 10 for analyzing binary data, such as for structure, according to various embodiments of the present invention. As shown in FIG. 1, the system 10 may comprise one or more processors 12 in communication with one or more memory units 14. For convenience, only one processor 12 and memory 14 are shown in FIG. 1. The memory 14 may comprise a binary data analysis software module 16. The module 16 may comprise code, which when executed by the processor 12, causes the processor 12 to determine the possible variances of structure sizes of binary data samples and to create or define a schema map (e.g., an XML schema map), as described further below. The binary data samples may be stored in a database 20.

The processor 12 may be a single or multiple core processor. The memory 14 may be embodied as any suitable computer-readable medium such as, for example, a RAM, a ROM, magnetic media such as a hard-drive or a floppy disk, or optical media such as a CD-ROM. The module 16 may be implemented as software code to be executed by the processor 12 using any suitable computer instruction type such as, for example, Java, C, C++, C#, Visual Basic, etc., using, for example, conventional or object-oriented techniques. The software code may be stored as a series of instructions or commands in or on the memory 14. The database 20 may be a relational database. The system 10 may be embodied as one or more networked computer devices, such as a personal computer, a laptop, a server, a workstation, a mainframe, etc.

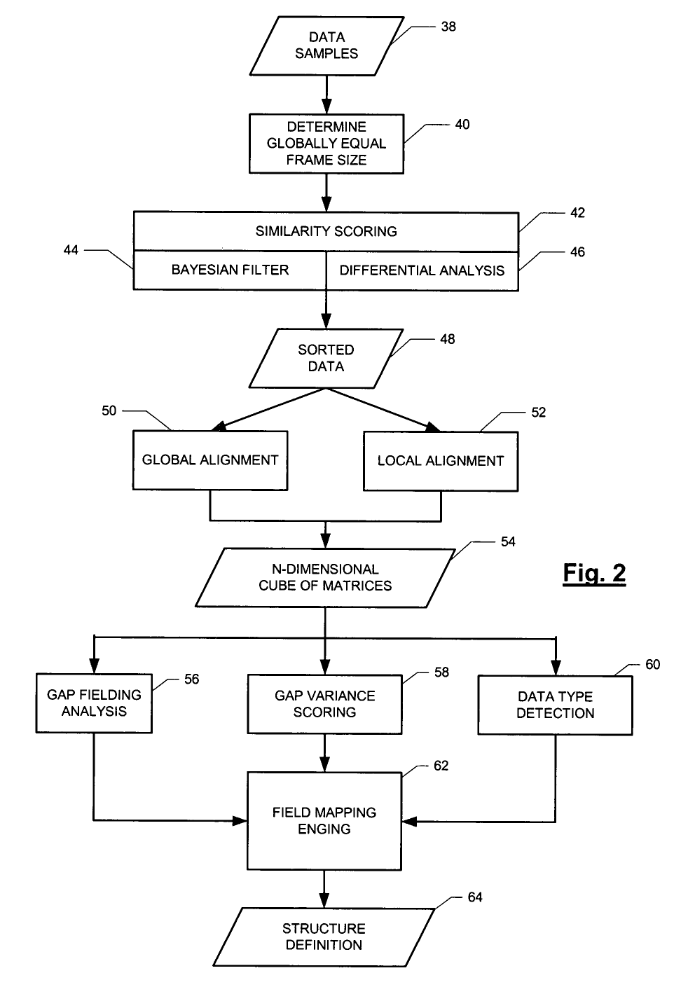

FIG. 2 is diagram of the process flow of the processor 12 when executing the code of the binary data analysis software module 16 according to various embodiments. The process may be performed on data samples 38. There must be at least two segmented data samples, and preferably there are hundreds, although the computations described below increase exponentially with the number of data samples. If there is only one data string, the data may be broken into two or more segments for the analysis. The samples may be the same or different lengths.

At step 40, a globally equal frame size for the data samples is determined. The globally equal frame size may be median data length of all of the data strings in the data samples. The globally equal frame size information may be used in subsequent steps, such as the Bayesian filter 44 and/or the differential analysis (step 46), the idea being to compare where data exists in the strings so there is not a penalty for strings being too long or too short.

Next, at step 42, the processor 12 may group and score the data strings by similarity. This may be done, according to various embodiments, by a Bayesian filter (or classifier) 44 that sorts and groups the data strings by likeness using Bayesian statistical methods, as is known in the art. Also, a differential or entropy analysis 46 may then be applied to the data to score the data strings based on similarity, as is known in the art. The output of this step may be sorted data strings 48 that are also scored based on similarity.

Global alignment (step 50) and local alignment (step 52) algorithms may then be applied to the data to recursively align the data. Global alignment may be the act of aligning data strings in which the two data strings are aligned from beginning to end. In various embodiments, the Needleman-Wunsch algorithm may be used for the global alignment step. The Needleman-Wunsch algorithm is a dynamic programming algorithm that operates on a matrix. It is commonly used and well known in bioinformatics to align protein or nucleotide sequences to detect known structure in the sequences, but here is being used to determine structure in the binary data strings.

To align to binary data strings A and B, one data string (data sting B) may be placed in the top of the matrix and the other data string (string A) may run down the left side. According to various embodiments, the Needleman-Wunsch algorithm generally involves three steps: similarity scoring; summing; and back-tracing. Assume the matrix M is a N+1 by M+1 matrix, where data string A has M characters and data string B has N characters. The matrix may be initialized with a zero in each cell. For the first step, similarity scoring, each cell in the matrix may be scored based on the matching similarity between each character in the data strings. The value “1” may be used to score a match. Mismatches can be scored as “0”. The second step of summing the matrix M may start at cell (1, 1), and each cell may be evaluated using the following function:

$${M}_{ij} = max \{ \begin{matrix}{M}_{i - 1 , j - 1} + {S}_{ij} \\ {M}_{i , j - 1} + w \\ {M}_{i - 1 , j} + w\end{matrix}$$

where Mᵢⱼ is the cell at row i, column j of matrix M, S is the score computed in step one and w is equal to the gap penalty. A gap penalty is not required for the operation of the Needleman-Wunsch algorithm, but is preferably used to improve alignments between more distant sequences.

The last step in the Needleman-Wunsch algorithm, back-tracing, may involve starting at the cell with the highest score and following from there a path that maximizes the alignment score back to the origin. According to various embodiments, the upper, left, and diagonal cell may be assessed to determine the cell with the highest score. If all cells are equal, the diagonal cell may be followed for the path. If moving left, a gap may be inserted into data string B, and if moving right, a gap may be inserted into data string A. According to various embodiments, similarity matrices may also be used to aid in the process of calculating match scores and improving overall alignment.

The local alignment step (step 52) may seek to find the most similar substring between two data strings. According to various embodiments, the local alignment step may employ the Smith-Waterman alignment algorithm. The Smith-Waterman alignment algorithm, like the Needleman-Wunsch algorithm, is a dynamic programming algorithm that compares segments of all possible lengths and optimizes the similarity measure. The Smith-Waterman alignment algorithm is derived from the Needleman-Wunsch algorithm, but unlike the Needleman-Wunsch algorithm, the Smith-Waterman alignment algorithm requires a gap penalty to work correctly. The Smith-Waterman alignment algorithm may employ the same general steps as the Needleman-Wunsch algorithm, except that the value “2” may be used for a match score, a value of “−1” may be used for a mismatch score, and a value of “−2” may be used for a gap penalty. When the initial matrix is initialized for the Smith-Waterman alignment algorithm, the left most row and upper most column may be filled with values starting at “0” and ending at 0 minus the length of the sequences. The Smith-Waterman alignment algorithm may behave just like the Needleman-Wunsch algorithm except that it may return from the trace-back step when it reaches a cell with a value of 0.

Since in various scenarios the system 10 will be analyzing more than two binary data samples, the matrices used in the global and local alignment steps may be n-dimensional hypercubes, where n is related to the number of data samples being analyzed. More details regarding the Needleman-Wunsch algorithm may be found in Needleman et al., “A general method applicable to the search for similarities in the amino acid sequence of two proteins,” J Mol Biol. 48(3):443-53 (1970). More details about the Smith-Waterman algorithm may be found in Smith et al., “Identification of Common Molecular Subsequences,” J Mol Biol. 147: 195-197 (1981).

The output of the alignment steps (block 54) may be the recursively aligned matrices and a gap chart that indicates the most appropriate places for the gaps. A number of steps may then be performed on the matrices. At step 56, the processor 12 performs a gap fielding analysis. This step may involve determining the size of the gaps. The gap variance scoring, at step 58, may determine the variance in the size of the gaps. And at step 60, the type of data (e.g., integer, hard set string) represented by the data strings may be detected. The type of data may be determined based on, among other things, the size of the fields, its propensity for change, the values of the characters in the field, etc.

The results from steps 56-60 may be used by a field mapping engine 62 that creates a length-based schema map (block 64) of the similar segments within the data. According to various embodiments, the structure definition 64 may be expressed as an XML schema map, although in other embodiments other formats may be used. The schema map may define, for example, the data types in the data samples (or that the data type is not known), the specific length of the fields, and whether the length changes. In other words, the field mapping engine 62 may determine the possible variances of structure size (1-n byte gaps), and plot the structures in a definable XML schema (or other format).

The schema may be stored in the memory 14 or some other memory or store associated with the system 10. The schema could also be transmitted in one or more files to another computer device/system via a network (not shown), such as a LAN, MAN, WAN, etc.

The schema may be used to test software or computer-based application. For example, the schema could be used to generate a create number of arbitrary files (e.g., thousands of files) based on the schema. Those files could then be run through the application to see how the application performs, e.g., to see if the application crashes. Another use of the schema is reverse engineering an application. Using the above-described process, a schema based on output binary data files from the application to be reverse-engineered may be generated. The structure of these files may then be ascertained, which may be beneficial to creating applications that interface with the application.

The examples presented herein are intended to illustrate potential and specific implementations of the embodiments. It can be appreciated that the examples are intended primarily for purposes of illustration for those skilled in the art. No particular aspect or aspects of the examples is/are intended to limit the scope of the described embodiments.

It is to be understood that the figures and descriptions of the embodiments have been simplified to illustrate elements that are relevant for a clear understanding of the embodiments, while eliminating, for purposes of clarity, other elements. For example, certain operating system details and modules of network platforms are not described herein. Those of ordinary skill in the art will recognize, however, that these and other elements may be desirable in a typical processor or computer system. However, because such elements are well known in the art and because they do not facilitate a better understanding of the embodiments, a discussion of such elements is not provided herein.

In general, it will be apparent to one of ordinary skill in the art that at least some of the embodiments described herein may be implemented in many different embodiments of software, firmware and/or hardware. The software and firmware code may be executed by a processor or any other similar computing device. The software code or specialized control hardware which may be used to implement embodiments is not limiting. For example, embodiments described herein may be implemented in computer software using any suitable computer software language type such as, for example, C or C++ using, for example, conventional or object-oriented techniques. Such software may be stored on any type of suitable computer-readable medium or media such as, for example, a magnetic or optical storage medium. The operation and behavior of the embodiments may be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes associated with the present embodiments may be executed by programmable equipment, such as computers or computer systems and/or processors. Software that may cause programmable equipment to execute processes may be stored in any storage device, such as, for example, a computer system (non-volatile) memory, an optical disk, magnetic tape, or magnetic disk. Furthermore, at least some of the processes may be programmed when the computer system is manufactured or stored on various types of computer-readable media. Such media may include any of the forms listed above with respect to storage devices and/or, for example, a modulated carrier wave, or otherwise manipulated, to convey instructions that may be read, demodulated/decoded, or executed by a computer or computer system.

It can also be appreciated that certain process aspects described herein may be performed using instructions stored on a computer-readable medium or media that direct a computer system to perform the process steps. A computer-readable medium may include, for example, memory devices such as diskettes, compact discs (CDs), digital versatile discs (DVDs), optical disk drives, or hard disk drives. A computer-readable medium may also include memory storage that is physical, virtual, permanent, temporary, semi-permanent and/or semi-temporary. A computer-readable medium may further include one or more data signals transmitted on one or more carrier waves.

A “computer,” “computer system” or “processor” may be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein may include memory for storing certain software applications used in obtaining, processing and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable media.

In various embodiments disclosed herein, a single component may be replaced by multiple components and multiple components may be replaced by a single component, to perform a given function or functions. Except where such substitution would not be operative, such substitution is within the intended scope of the embodiments. Any servers described herein, for example, may be replaced by a “server farm” or other grouping of networked servers that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand and/or providing backup contingency in the event of component failure or reduction in operability.

While various embodiments have been described herein, it should be apparent that various modifications, alterations and adaptations to those embodiments may occur to persons skilled in the art with attainment of at least some of the advantages. The disclosed embodiments are therefore intended to include all such modifications, alterations and adaptations without departing from the scope of the embodiments as set forth herein.

What is claimed is:

1. A system for determining structure of two or more binary data strings comprising:
a processor; and
a memory in communication with the processor, wherein the memory stores instructions which when executed by the processor causes the processor to:
sort the data strings by similarity;
recursively align the data strings; and
create a length-based schema map of similar segments in the data strings.

2. The system of claim 1, wherein the memory stores instructions which when executed by the processor cause the processor to recursively align the data strings using a global alignment algorithm.

3. The system of claim 2, wherein the global alignment algorithm is based on the Needleman-Wunsch algorithm.

4. The system of claim 1, wherein the memory stores instructions which when executed by the processor cause the processor to recursively align the data strings using a local alignment algorithm.

5. The system of claim 2, wherein the local alignment algorithm is based on the Smith-Waterman algorithm.

6. The system of claim 1, wherein the memory stores instructions which when executed by the processor cause the processor to recursively align the data strings using:
a global alignment algorithm; and
a local alignment algorithm.

7. The system of claim 6, wherein:
the global alignment algorithm is based on the Needleman-Wunsch algorithm; and
the local alignment algorithm is based on the Smith-Waterman algorithm.

8. The system of claim 6, wherein the memory stores instructions which when executed by the processor cause the processor to sort the data strings by similarity using a Bayesian classifier.

9. The system of claim 8, wherein the memory stores instructions which when executed by the processor cause the processor to score the data strings based on similarity prior to recursively aligning the data strings.

10. The system of claim 8, wherein the memory stores instructions which when executed by the processor cause the processor to create a length-based schema map of similar segments in the data strings by:
determining the size of gaps in the data strings for gaps detected in the recursive alignment;
determining a variance in the size of the gaps; and
detecting a type of data represented by the segments.

11. The system of claim 10, wherein the length-based schema map comprises a XML-length-based schema map.

12. The system of claim 1, wherein the length-based schema map comprises a XML-length-based schema map.

13. A method for determining structure of two or more binary data strings comprising:
sorting the data strings by similarity;
recursively aligning the data strings; and
creating a length-based schema map of similar segments in the data strings.

14. The method of claim 13, wherein recursively aligning the data strings comprises:
using a recursive global alignment algorithm for a global alignment; and
using a recursive local alignment algorithm for a local alignment.

15. The method of claim 14, wherein:
the global alignment algorithm is based on the Needleman-Wunsch algorithm; and
the local alignment algorithm is based on the Smith-Waterman algorithm.

16. The method of claim 15, wherein sorting the data strings by similarity comprises sorting the data strings using a Bayesian classifier.

17. The method of claim 16, further comprising scorings the data strings based on similarity prior to recursively aligning the data strings.

18. The method of claim 17, wherein creating the length-based schema map of similar segments comprises:
determining the size of gaps in the data strings for gaps detected in the recursive alignment;
determining a variance in the size of the gaps; and
detecting a type of data represented by the segments.

19. The method of claim 18, wherein the length-based schema map comprises a XML-length-based schema map.

20. A computer readable medium having stored thereon instructions which when executed by a processor cause the process to determine structure of two or more binary data strings by:
sorting the data strings by similarity;
recursively aligning the data strings; and
creating a length-based schema map of similar segments in the data strings.

21. The computer readable medium of claim 20, having further stored thereon instructions which when executed by the processor cause the processor to recursively align the data strings using:
a global alignment algorithm; and
a local alignment algorithm.

22. The computer readable medium of claim 21, wherein:
the global alignment algorithm is based on the Needleman-Wunsch algorithm; and
the local alignment algorithm is based on the Smith-Waterman algorithm.

23. The computer readable medium of claim 22, having further stored thereon instructions which when executed by the processor cause the processor to sort the data strings by similarity using a Bayesian classifier.

24. The computer readable medium of claim 23, having further stored thereon instructions which when executed by the processor cause the processor to score the data strings based on similarity prior to recursively aligning the data strings.

25. The system of claim 24, having further stored thereon instructions which when executed by the processor cause the processor to create a length-based schema map of similar segments in the data strings by:
determining the size of gaps in the data strings for gaps detected in the recursive alignment;
determining a variance in the size of the gaps; and
detecting a type of data represented by the segments.
